(19) United States
(12) Patent Application Publication
(10) Pub. No.: US 2010/0274727 A1
(43) Pub. Date: Oct. 28, 2010

(54) System, method and computer program product for forming two or more contracts from offers sharing a plurality of unified terms and conditions

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 12/386,852

(22) Filed: Apr. 22, 2009

(51) Int. Cl. G06Q 30/00; G06Q 50/00; G06F 21/00

(52) U.S. Cl. 705/80; 726/28

(57) ABSTRACT

A method system and computer product are provided to drive a process that includes the aspects of method generating an executed license agreement by presenting a licensing offer via a computer and receiving an acceptance by a user of the computer of the licensing offer. The licensing offer may apply to one or more products, software programs, or software services. A web service may alternatively or additionally be authorized by the licensing offer upon receipt of an acceptance by the user of the licensing offer.

### BACKGROUND OF THE INVENTION

1. Technical Field

The present invention generally relates to method and systems for offering license terms and conditions. The present invention more particularly relates to a method and system for generating license agreements.

2. Background Art

Product and service licenses are authorizations for a licensee to access a service, and/or use, modify and/or copy a product. The process of generating a license may be crafted by an authorized licensor to require a potential licensee to affirmatively acknowledge and accept one or more terms or conditions. A term or condition of a license may state that the validity of the license is dependent upon a licensee performing, or not performing, one or more acts. The recordation of an acceptance of terms and conditions of a license may be required by law and/or desirable by a licensor in order to assert a right of the licensor to revoke, modify or limit a previously issued license.

A license is a legal a document and therefore may be embodied as a physical object. The process of transformation by means of a computer of an offer to license a product to an actually issued license is therefore a representation of the generation of an actual physical document, i.e., an executed license agreement.

Given the increasingly common use of licensing, particularly of software services and programs, it may be desirable to present license terms and conditions to a potential licensee by means of an information technology system. In the prior art, license terms and conditions of software programs and services are often presented to a user by a display screen of a computer, and an acknowledgment of acceptance by the user is receivable by the same computer. Acceptances of license terms and conditions may be stored in the receiving computer, stored in electronic media, printed in hard copy and/or communicated from the computer to a remote server.

Yet the prior art does not optimally address the reality that reading software licenses can be tedious and unappealing to many computer users. In addition, the desire of most computer users to access multiple software programs from a same computer can result in a user feeling overwhelmed by a requirement to read separate license agreements for each software program or service. This requirement imposed upon a computer user by the licensor, and often necessary by law, to represent both an understanding of license terms and conditions as well as an agreement to comply with an individual set of license terms and conditions in order to receive a legitimate yet revocable authorization to access, modify or copy a specified product, software product or service can discourage a user from spending the time required to actually understand the terms and conditions of an offered license. In addition, license terms and conditions of many similar types of products or services, and in particular of licenses for many types of software programs and services, are not unusually quite similar. A computer user may thus be asked by a licensor to carefully and thoroughly read separate and individual terms and conditions of many different software programs, wherein the actual terms and conditions of many of these software licenses are largely identical in meaning and scope.

There is therefore a long-felt need to expedite the effective evaluation of a set of terms and conditions of an offer to license a product or service by a potential licensee.

### SUMMARY OF THE INVENTION

This and other objects of the present invention are made obvious in light of this disclosure, wherein methods, systems and computer program product for enabling a computational device (hereinafter “computer”) to selectively offer access to computational functionalities at least partly on then basis of information regarding, or provided by, a user.

A first aspect of the method of the present invention provides a computer-implemented method for generating an executed license agreement by presenting a licensing offer via a computer and receiving an acceptance by a user of the computer of the licensing offer. The licensing offer may apply to one or more products, software programs, or software services. A web service may alternatively or additionally be authorized by the licensing offer upon receipt of an acceptance by the user of the licensing offer.

A user issued acceptance may be input by the user to the computer, stored in computer-readable media and/or communicated to a remote server. Alternatively or additionally, a recordation of the acceptance may be communicated from the computer by means of an electronics communications network, e.g., the Internet, a telephony network, or a computer network.

According to a second aspect of the method of the present invention, the acceptance of the terms and conditions of a licensing offer may be applicable to the process of executing separate licenses of two or more products, software programs, and/or services. According to another aspect of the method of the present invention, an authorized product, software program or service may be or comprise a process that may at least partially be performed by the computer.

According to a still other aspect of the method of the present invention, one or more additional terms or conditions may be presented to the user, wherein the one or more additional terms or conditions may be applicable in addition to a unified set of terms of conditions in a licensing offer directed to a authorized product, software program or service.

According to yet another aspect of the method of the present invention, an information technology system or network may be provided that includes one or more processors, memory circuitry, a display device, and is configured with a process to present a licensing offer via a first computer and receive an acceptance of the licensing offer by a user of the same or other computer. The first computer may identify a product, software program or service to which the licensing offer is directed.

In still another optional aspect of the method of the present invention a computer is provided that enables a user to direct the execution of one or more aspects of the method of the present invention.

In still another optional aspect of the method of the present invention a computer-readable medium is provided that when executed by a computer may cause the computer to perform one or more aspects of the method of the present invention.

The foregoing and other objects, features and advantages will be apparent from the following description of aspects of the present invention as illustrated in the accompanying drawings.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

U.S. Pat. Nos. 5,708,709 (Inventor: Rose, J.; issued on Jan. 13, 1998) titled “System and method for managing try-and-buy usage of application programs”; 7,143,409 (Inventor: Herrero, V.; issued on Nov. 28, 2006) titled “Automated entitlement verification for delivery of licensed software”; 7,149,721 (Inventor: Sites, et al.; issued on Dec. 12, 2006) titled “Electronic content rights with and-or expression”; 7,382,879 (Inventor: Miller, E.; issued on Jun. 3, 2008) titled “Digital rights management negotiation for streaming media over a network”; 7,516,104 (Inventor: Scardino, P.; issued on Apr. 7, 2009) titled “Methods of providing software over a network and related systems and computer program products”; 7,251,617 (Inventors: Walker, et al.; issued on Jul. 31, 2007) titled “Method and apparatus for managing subscriptions”; 7,031,943 (Inventors: James, et al.; issued on Apr. 18, 2006) titled “Digital license agreement”; 7,512,782 (Inventors: Kaler, et al.; issued on Mar. 31, 2009) titled “Method and system for using a web service license”; 7,506,382 (Inventors: Padole, et al.; issued on Mar. 17, 2009) issued on “Method and system for licensing a software product”; and United States Patent Application Publication Serial No. 20090012805 (Inventors: Schnell, et al.; published on Jan. 8, 2009) titled “Portable Digital Rights for Multiple Devices”; United States Patent Application Publication Serial No. 20080320601 (Inventor: Linsley, David J.; published on Dec. 25, 2008) titled “PROVIDING ACCESS RIGHTS TO PORTIONS OF A SOFTWARE APPLICATION”; and United States Patent Application Publication Serial No. 20080243699 (Inventors: Hilerio; Israel, et al.; published on Oct. 2, 2008) titled “License optimization and automated management” are each incorporated herein by reference in their entirety and for all purposes.

All publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 presents a prior art process of offering a license and receiving an acceptance of the terms and conditions of the license by a potential licensee;

FIG. 2 presents a prior art process of, by means of a computer, a licensor issuing a license offer, receipt by the licensor of an acceptance of the terms and conditions of the license offer, and a transformation of the license offer into a license;

FIG. 3 is an exemplary text that may be comprised within the software license offer of FIG. 2;

FIG. 4 is an illustration of the exemplary text of FIG. 3 displayed on a display screen of the computer of FIG. 2;

FIG. 5 is an illustration of the display screen of FIG. 4 of the computer of FIG. 2 presenting a plurality of offers in accordance with a first aspect of the method of the present invention;

FIG. 6 is a flow chart of a first process of the computer of FIG. 2 wherein a second aspect of the method of the present invention may be performed, and two or more acceptances, each for a different and separate license, may be received and processed;

FIG. 7 is a schematic diagram of a license matrix as stored as a software data structure in the computer of FIG. 2;

FIG. 8 is a flow chart of a second process of the computer of FIG. 2 wherein a third aspect of the method of the present invention may be performed, and two or more acceptances, each for a different and separate license, may be further processed;

FIG. 9 is a flow chart of a third process of the computer of FIG. 2 wherein a fourth aspect of the method of the present invention may be performed, and one or more additional terms or conditions may be offered to the user of the computer of FIG. 2 and accepted, and one or more additional licenses may be authorized;

FIG. 10 is a flow chart of a process whereby the computer of FIG. 2 may detect or receive an alert of a violation of an authorized license and thereupon record a license revocation and disable a licensed software or web service;

FIG. 11 is a flow chart of a process whereby the computer of FIG. 2 may generate a hard copy of the authorized license of FIG. 7 may be generated;

FIG. 12 is a schematic diagram of the computer of FIG. 2;

FIG. 13 is a schematic diagram of the system software of the computer of FIG. 2; and

FIG. 14 is a schematic diagram of the electronics communications network comprising the computer of FIG. 2; and

FIG. 15 is a flowchart of a computer implemented process wherein a still alternate aspect of the method of the present invention is practiced when the computer of FIGS. 12, 13 and 14 is offline and/or not in communication with the network 1 and/or the remote servers of FIG. 14.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Embodiments of method for allocating memory during pre-boot in a manner that facilitates efficient hand-off to an operation system and computer apparatus for implementing the method are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one aspect” or “an aspect” means that a particular feature, structure, or characteristic described in connection with the aspect is included in at least one process or hardware configuration that is in accordance with the method of the present invention. Thus, the appearances of the phrases “in one aspect” or “in an aspect” in various places throughout this specification are not necessarily all referring to the same instantiation of the method of the present invention. Furthermore, each particular aspect of the method of the present invention, may be included in singularity or in combination in any suitable manner in one or more systems or methods.

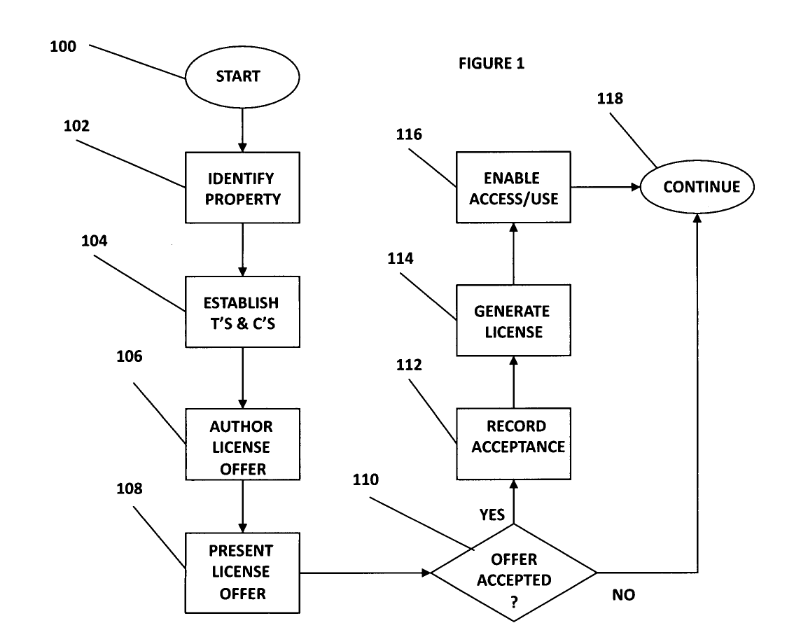

Referring now to FIG. 1, FIG. 1 presents a prior art process of offering a license and receiving an acceptance of the terms and conditions of the license by a potential licensee. In step 102 a licensor identifies a property and establishes a scope of use of and/or access to the selected property to be authorized by a license. In step 104 the licensor establishes a set of terms and conditions under which the scope of use of the property of step 102 may be authorized. These terms and conditions may specify a proscribed behavior, or failure to act, by the licensee that would result in the license being revocable by the licensor. In step 106 the identification of the property, the scope of use of the property under the license, and the terms and conditions of the license are combined into a license offer. It is understood that the license offer is not an authorized license, but merely an offer to license.

The license offer is presented to a potential licensee in step 108. The licensor determines in step 110 whether the licensee has communicated an acceptance of the license offer, and may proceed to store a record of the potential licensee's acceptance in step 112. The licensor may require that the acceptance communicated by a potential licensee be in a legally valid and binding form, e.g., comprising a hand written signature or an electronic signature. The licensor proceeds from step 112 to step 114 to generate a license, whereby the potential licensee's status is transformed to a status as a licensee, and the license offer is transformed into a license. The licensor proceed, in certain instances, from step 114 to step 116 to enable the use of and/or access to the licensed property within the scope of use and the terms and conditions of the license offer and as now included in the license.

The license, license offer, and acceptance may be legally recognizable and tangible documents that may be embodied, represented by, and/or stored in a hard copy printed document, and alternately or additionally as separate or combined electronic documents containing textual and/or graphical data.

When the licensor determines in step 110 that the licensee has not provided an acceptable acceptance of the license offer, and the licensor may proceed to step 118 and to offer additional and/or alternate licenses to other parties and perform other business activities.

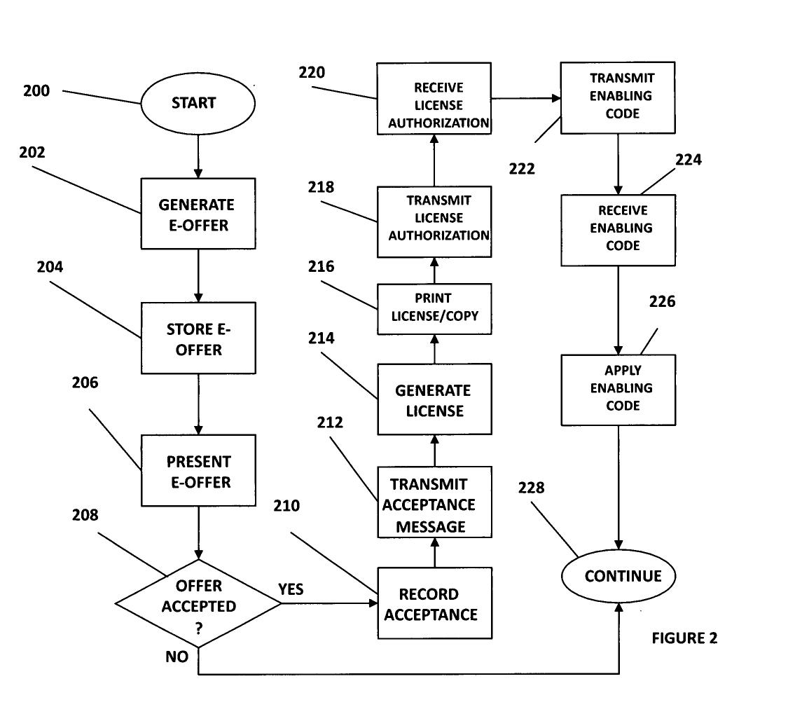

Referring now to FIG. 2, FIG. 2 presents a prior art process wherein a computer 100, a remote server 102 and/or a communications network 104 may be used to enable a licensor to (a.) present a software license offer 106 for, or for use of, a software program 108.A-108.N; (b) receive an acceptance 110 of the terms and conditions 112 of the license offer 106 by a potential licensee; and (c.) transforming a license offer 106 into a license 114. It is understood that the software program 108.A-108.N may enable a software enabled service, such as a web service.

In step 202 the license offer 106 for a software program 108.A-108.N or web service is generated as an electronic document (hereinafter “e-offer” 106). The e-offer 106 is stored in a computer 100 in step 204. The e-offer 106 may be provided to the computer 100 by recordation onto an electronic media 116 of the computer 100 by a manufacturer of the computer 100, or by an other actor in the stream of commerce wherein the e-offer 106 is presented to a user during an out of the box experience of the user and partially or wholly within step 206. In step 206 the e-offer 106 is visually displayed by the computer 100, wherein the software program 108.A-108.N or the web service is identified, the scope of use and/or access is delineated, and the terms and conditions are presented.

The computer 100 determines in step 208 whether an acceptance message 118 has been received by the computer 100 via a user input device 120, wherein the acceptance message 118 indicates that the user desires to received a license for the software program 108.A-108.N or web service identified in the e-offer 106. When the computer 100 determines in step 208 that the input device 120 has issued an acceptance message 118, the computer 100 proceeds to step 210 to record the acceptance message 118 in the electronic media 116 (or “computer program product” 116). The computer 100 may optionally transmit the acceptance message 118 in step 212 to a remote server 102 via an electronic communications network 104, e.g., the Internet, a computer network, and/or a telephony network such as a wireless telephone network. In step 214 the computer 100 or optionally the server 102 transforms the e-offer 106 into an authorized license 114, and stores an electronic original 122 or electronic copy 124 of the license 114. In optional step 216 the server 102 publishes a hard copy 126 of the authorized license 114 or storage or review. The authorized license 114 may include an identification of the computer 100, an identification of a user, a time and date of the license issuance, and the e-offer 106.

In optional step 218 the server 102 transmits an issuance authorization 128 of the license from the server 102, and in optional step 220 the computer 100 receives the authorization of a license.

Additionally, optionally or alternately, in optional step 222 the server 102 transmits an enabling software code 130 to the computer 100, wherein the enabling software code 130 may be applied by the computer 100 to enable at least part of the scope of use of the e-offer 106 as displayed in step 206. The computer 100 receives the enabling software code 130 in optional step 224.

The computer 100 authorizes and enables use of and/or access to the software program 108.A-108.N or web service in step 226. The computer 100 proceeds from step 226 to step 228 and to perform alternate computational operations.

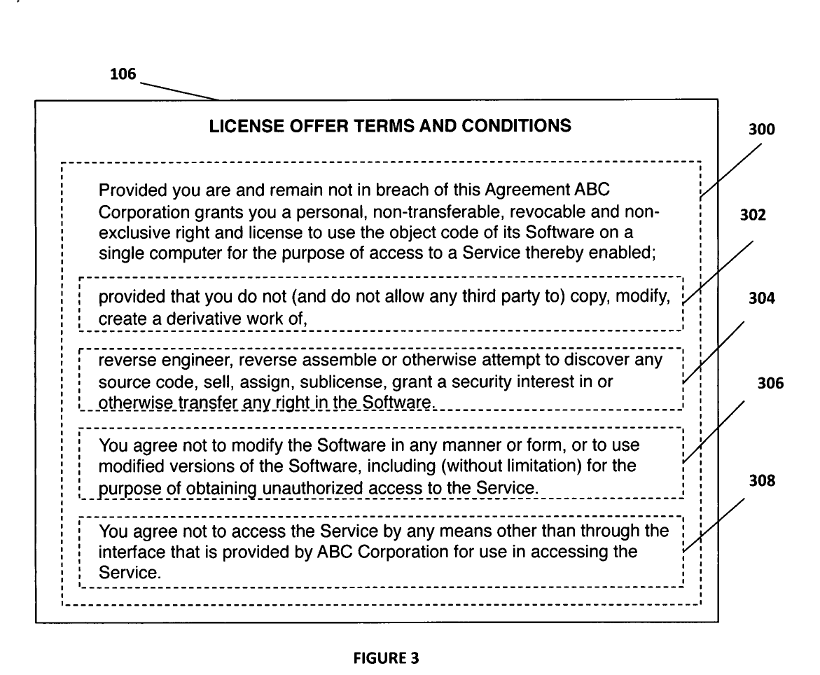

Referring now generally to the Figures and particularly to FIG. 3, FIG. 3 is an exemplary text 300 that may be comprised within the e-offer 106 of step 202 and authorized license of step 214. The exemplary text 300 includes the following verbiage:
“Provided you are and remain not in breach of this Agreement ABC Corporation grants you a personal, non-transferable, revocable and non-exclusive right and license to use the object code of its Software on a single computer for the purpose of access to a Service thereby enabled; provided that you do not (and do not allow any third party to) copy, modify, create a derivative work of, reverse engineer, reverse assemble or otherwise attempt to discover any source code, sell, assign, sublicense, grant a security interest in or otherwise transfer any right in the Software. You agree not to modify the Software in any manner or form, or to use modified versions of the Software, including (without limitation) for the purpose of obtaining unauthorized access to the Service. You agree not to access the Service by any means other than through the interface that is provided by ABC Corporation for use in accessing the Service.”

In the exemplary text 300 the licensor is identified in the e-offer 106 as an ABC Corporation. The scope of the license is identified as being access to a Service that is enabled by use of an identified software program 108.A-108. N on the computer 100. A first condition 302 requires that a licensee not, nor allow a third party to, “copy, modify, create a derivative work of, reverse engineer, reverse assemble or otherwise attempt to discover any source code” of the identified software program 108.A-108.N. A second condition 304 requires that a licensee not, nor allow a third party to, “sell, assign, sublicense, grant a security interest in or otherwise transfer any right in the Software [108.A-108.N]” nor attempt to, “sell, assign, sublicense, grant a security interest in or otherwise transfer any right in the Software [108.A-108.N]”. A third condition 306 requires a licensor to “agree not to modify the Software in any manner or form, or to use modified versions of the Software [108.A-108. N], including (without limitation) for the purpose of obtaining unauthorized access to the Service”. A fourth condition 308 requires that the user agree to not “access the Service by any means other than through the interface that is provided by ABC Corporation for use in accessing the Service”.

A breach of any one of these four conditions 302-308 may result in the licensor having legal grounds to revoke an authorized license without liability.

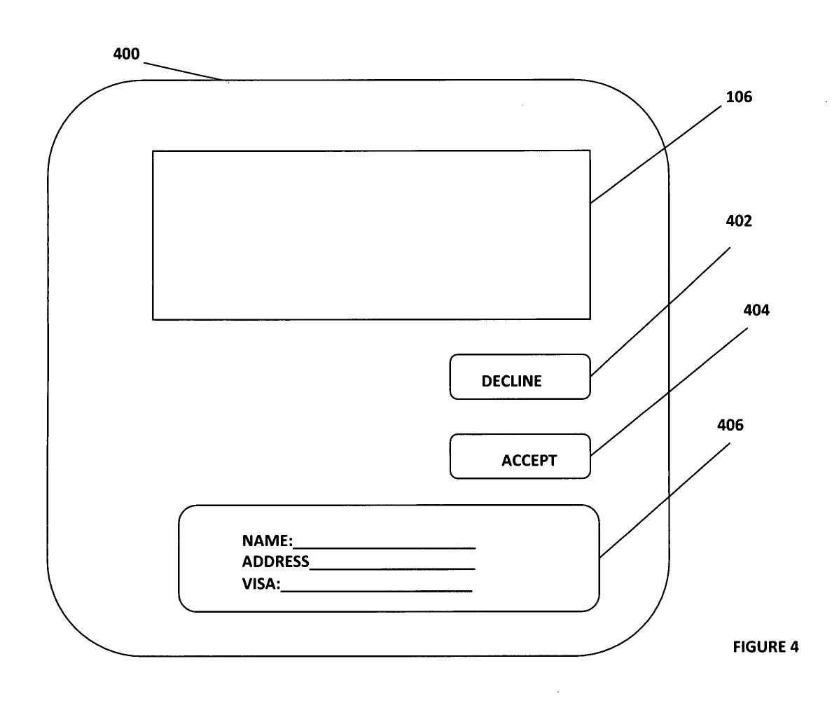

Referring now generally to the Figures and particularly to FIG. 4, FIG. 4 is an illustration of the exemplary text 300 displayed on a display screen 400 of the computer 100. The display screen 400 further presents a decline icon 402 and an accept icon 404. The user may communicate a decision to decline the e-offer 106 by using the input device 120 to select the decline icon 402. Alternately, the user may communicate a decision to accept the e-offer 106 by using the input device 120 to select the accept icon 404. Upon receipt of a user selection of the decline icon 402, the computer 100 may optionally inform the remote server 102 of the user selection of the decline icon 402. Alternatively, upon receipt of a user selection of the accept icon 404, the user may optionally inform the remote server 102 of the user selection of the accept icon 404. The user may additionally be prompted by the computer 100 to input a name and address associated with the user by means of the input device and an interactive menu 406 as displayed on the display screen 400, where after the input name and address may be transmitted by the computer 100 to the remote server 102.

In the prior art, a user may be required by and/or prompted to review a plurality of substantially similar e-offers 106. Each request to review an e-offer 106 made by the computer 100 may be considered as an invitation to a tedious experience by the user. This tedium may degrade the quality of the user experience in a consideration of a purchase of a software program license or access to a web service. Sales revenue and/or user base growth may thereby be reduced, degraded or slowed by multiplicity of requests directed to the user that require a review and acceptance of an e-offer 106.

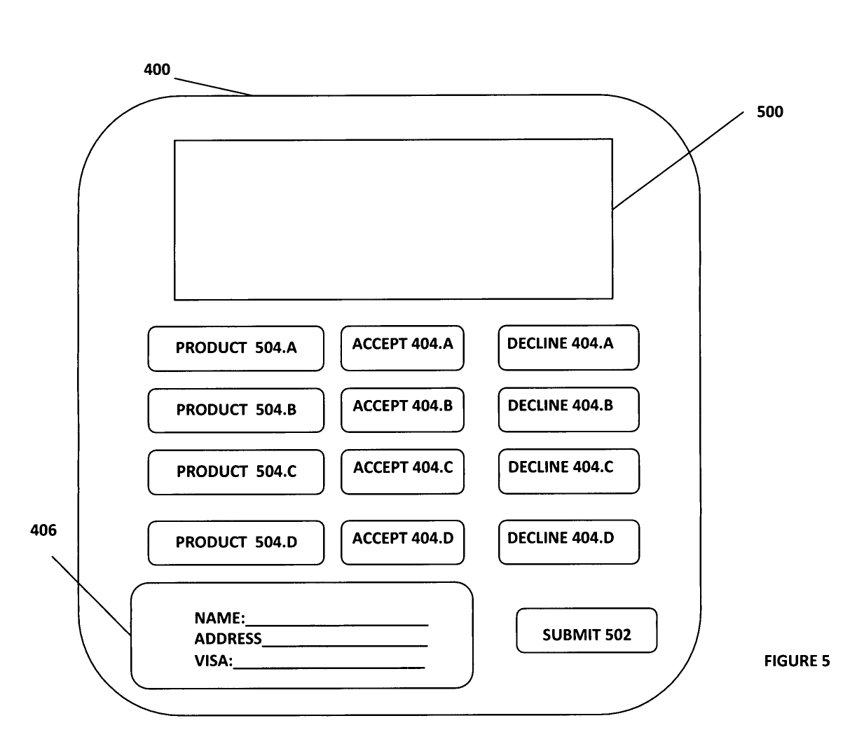

Referring now generally to the Figures and particularly to FIG. 5, FIG. 5 is an illustration of the display screen 400 presenting a plurality of e-offers 106 in accordance with a first aspect of the method of the present invention. A unified e-offer 500 is presented along with a submit icon 502, plurality of product images 504.A-504.N, accept icons 404.A-404.N, decline icons 402.A-404.N are displayed. Each individual accept icon 404.A-404.N is separately associated with an individual and unique product image 504.A-504.N. The selection of an accept icon 404.A-404.N by the user indicates an acceptance by the user of the unified e-offer 500, and all displayed terms and conditions thereof, in return for an issuance of an authorized license 506.A-506.N to use and/or access a software program 108.A-108.N, software service and/or a web service related to the associated product image 504.A-504.N.

The submit icon 502 is selected by the user to direct the computer 100 to process user selections of decline icons 402.A-402.N, accept icons 404.A-404.N, and product images 504.A-504.N.

The single interactive menu 406 enables the user to input a name and address that identifies the user as a party to each license 506.A-506.N issued in response to each selected product image 504.A-504.N, wherein selection of the product image 504.A-504.N may be affected by selection of an accept icon 404.A-404.N associated with the product image 504.A-504.N. It is understood that one or more product images 504.A-504.N may comprise an accept icon 404, whereby a user selection by means of the input device 120 of a product image 504.A-504.N may be interpreted by the computer 100 as an acceptance of the unified e-offer 500 by the user of the computer 100, a request for an authorized license 506.A-506. N of use of and/or access to a software program 108.A-108. N, software service and/or a web service related to the selected product image 540.A-504.N.

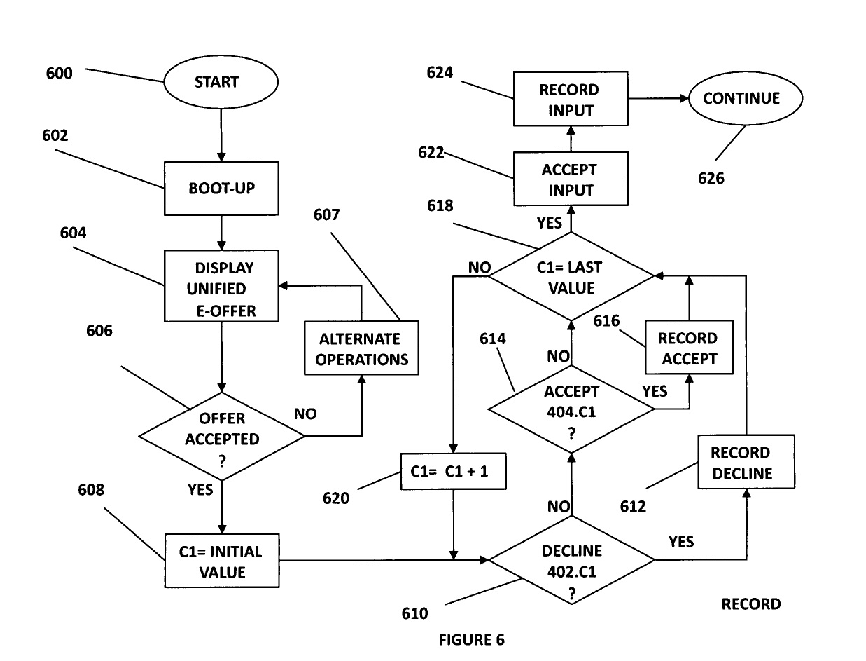

Referring now generally to the Figures and particularly to FIG. 6, the flow chart of FIG. 6 illustrates a first process of the computer of FIG. 2 wherein a second aspect of the method of the present invention may be performed, and two or more acceptances, each for a different and separate authorized license 506.A-506.N, may be received and processed.

In step 602 the computer 100 is booted up and instep 604 the display screen 400 presents the unified e-offer 500, the decline icons 402.A-402.N, the accept icons 404.A-404.N, and the product icons 504.A-504.N as illustrated in FIG. 5. In step 606 the computer 100 determines whether the submit icon 502 has been actuated.

When the computer 100 determines in step 606 that the submit icon 502 has been selected, the computer proceeds to step 608 and sets a first counter C1 to an initialization value, and proceeds therefrom to determine in step 610 whether a first decline icon 402.A has been selected. When the computer determines in step 610 that a decline icon 204.A has been selected, the computer 100 records the user act of declining in step 612. Alternatively, computer 100 may proceed from step 610 to step 614 and to determine whether a first accept icon 404.A has been selected in step 614. When the computer determines in step 614 that the first accept-icon 404.A has been selected, the computer 100 records the user act of acceptance in step 616.

The computer 100 proceeds from step 612, step 614, or step 616 to step 618 and to determine whether the first counter value C1 is equal to or greater than a last value of CLAST of the enumerated accept icons 404.A-404.N and decline icons 402.A-402.N. When the computer 100 determines in step 618 that the first counter value C1 is not equal to or greater than to the icon last value CLAST, the computer 100 proceeds to step 620 to increment the first counter value C1 and therefrom to execute another cycle of the steps 610 through 618.

When the computer 100 determines in step 618 that the first counter value C1 is equal to or greater than to the icon last value CLAST, the computer 100 proceeds to step 622 and to accept user input information from the single interactive menu 406. The computer 100 stores the user input information received in step 624, and proceeds on to additional computational operations in step 624. The computer 100 proceeds from step 624 to step 626 to perform alternate or additional computational operations.

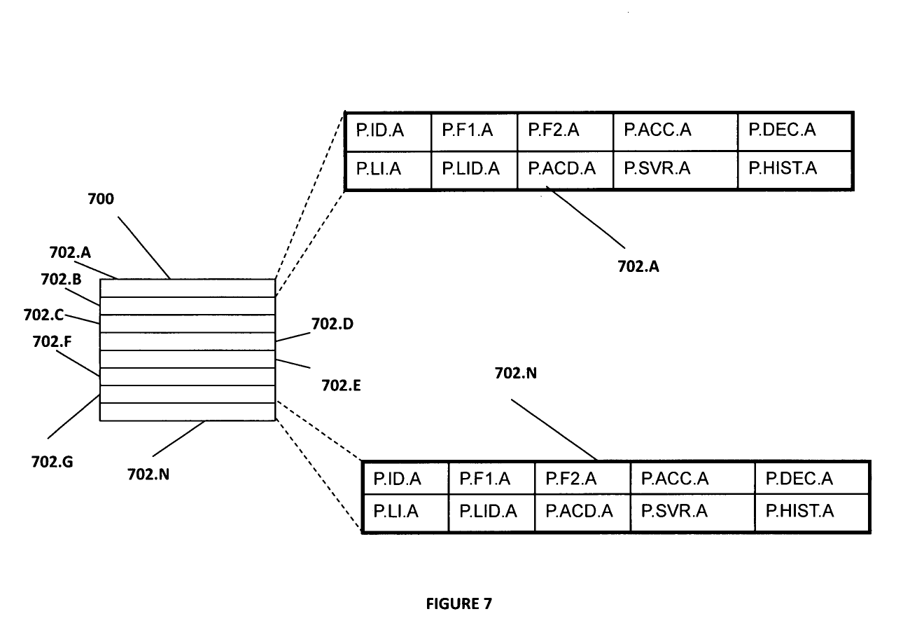

Referring now generally to the Figures and particularly to FIG. 7, FIG. 7 is a schematic diagram of a product license matrix 700 as stored in the computer 100. The product license matrix 700 (hereinafter “license matrix” 700) includes individual product records 702.A-702.N. Each product record 702.A-702.N refers to a particular software program 108.A-108. N or web service that may be referenced by a unique product identifier P.ID.A-P.ID.N that is stored in the relevant product record 702.A-702.N. Each product record 702.A-702.N further includes a first flag P.F1.A-P.F1-N that indicates whether an authorized user license 506.A-506.N for the identified product may be offered under the unified e-offer 500. A second flag P.F2.A-P.F2-N indicates whether any terms and conditions additional to the terms and conditions of the unified e-offer 500 shall be presented to, and must be accepted the user, in order to generate a user license 506.A-506.N for use of or access to the product referred to by the unique product identifier P.ID.A-PID.N. An accept data P.ACC.A-P.ACC.N contains data indicating if and when a user accepted the unified e-offer 500 and any additional conditions referred to by the second flag P.F2.A-P.F2.N. A decline data P.DEC.A-P.DEC.N contains data indicating if and when a user declined the unified e-offer 500 and any additional conditions referred to by the second flag P.F2.A-P.F2.N. A license info data P. LI.A-P.LI.N contains information recording if and when a license 506.A-506. N has been issued to one or more users for use of, or access to, the identified product, e.g., a software program 108.A-108.N, by the computer 100. A license identifier P.LID.A-P.LID.N contains information identifying a specific license 108.A-108.N issued that includes a scope of use of the product e.g., a software program 108.A-108.N, in the computer 100. A product access code P.ACD.A-P.ACD.N includes information that may be applied by the computer 100 to enable a software code related to, or comprised within, the product that may be referenced by association with the unique product identifier P.ID.A-P.ID.N. A server address P.SVR.A-P.SVER.N includes a network address of a server 102 or 704 that is associated with the product identified by the product identifier P.ID.A-P.ID.N. A product history data P.HIST.A-P.HIST.A includes data describing user interaction with the product identified by the product identifier P.ID.A-P.ID.N.

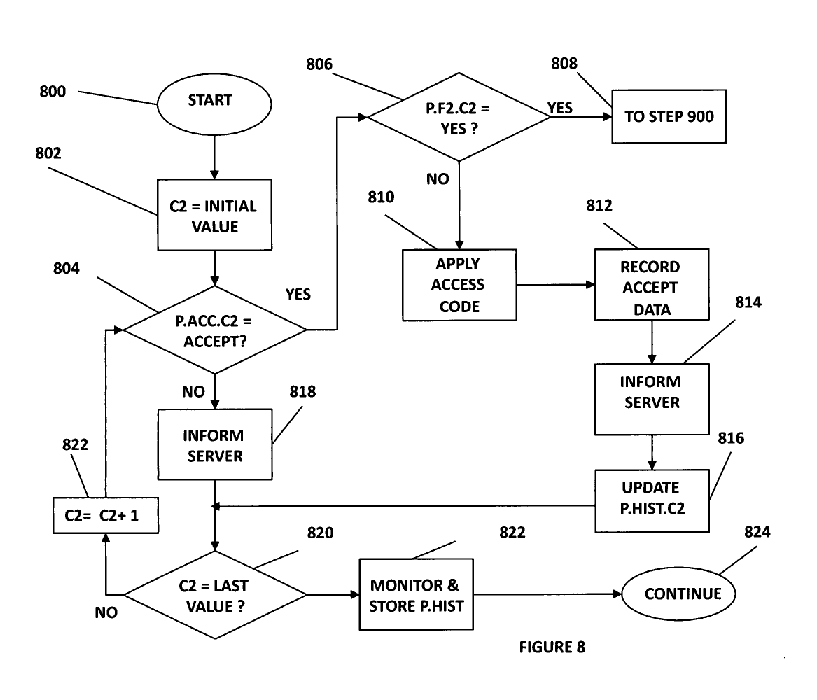

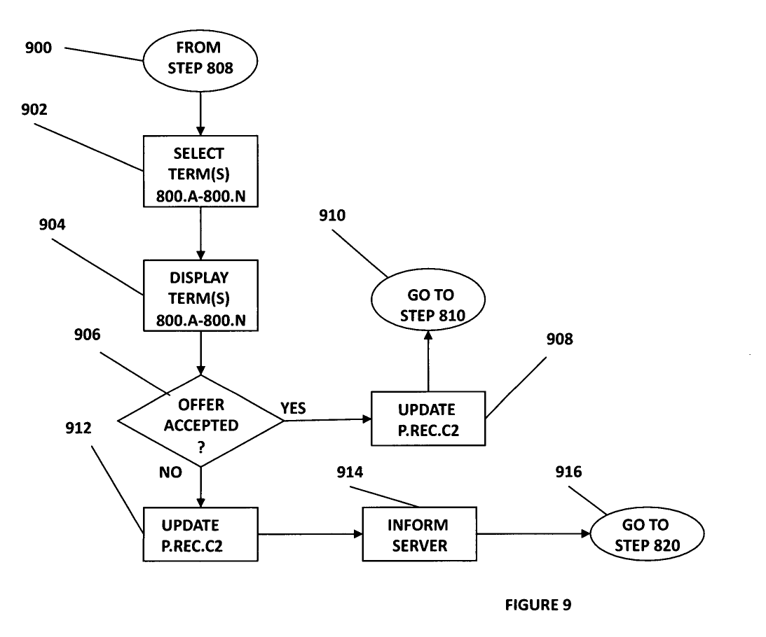

FIG. 8 is a flow chart of a second process of the computer 100 wherein a third aspect of the method of the present invention may be performed by the computer 100, and two or more acceptances, each for a different and separate license 506.A-506.N, may be processed. In step 802 a second counter C2 is set to an initial value, and the computer 100 determines in step 804 whether a product record P.REC.C2 indicates that a software program or web service identified by the product identifier P.ID.C2 has been accepted by the user. When the computer 100 determines in step 804 that the unified e-offer 500 of the selected product record P.REC.C2 has received an acceptance message from the user, the computer 100 proceeds on to step 806 to determine whether the P.REC.C2 indicates that an additional term or condition 800.A-800.N must be accepted by the user prior to issue a license 506.A-506. N for the indicated product. When the computer 100 determines that the P.REC.C2 indicates that an additional term or condition 800.A-800.N must be accepted by the user prior to issue a license 506.A-506. N for the licensed product, the computer proceeds from step 806 to step 808 and therefrom follows the software process described in reference to FIG. 9.

When the computer 100 determines in step 806 that the product record P.REC.C2 indicates that no additional term or condition must be accepted by the user prior to issue a license 506.A-506.N for the indicated product, the computer proceeds from step 806 to step 810. In optional step 810 the computer 100 selects and applies the product access code P.AC.C2 of the product record P.REC.C2 to enable a software code stored in the computer 100 to enable the instant software program or web service. The receipt of the acceptance message is then noted in the accept data P.ACC of the selected product record P.REC.C2 and archived in the computer 100 in step 812. The receipt of acceptance message may also be transmitted to the remote server 102 in step 814, and in step 816 the computer 100 updates the product history data P.HIST to include one or more notations of the executed steps of 804 through 814.

Referring now back to step 804, when the computer 100 determines in step 804 that the e-offer 106 of the selected product record P.REC.C2 has noted an acceptance message from the user, the computer 100 proceeds on to optional step 818 and to transmit a decline message to the remote server 102.

The computer 100 proceeds from step 816 or step 818 to step 820 and to determine whether the second counter C2 is equal or greater than the last value CLAST of the license matrix 700. When the computer 100 determines in step 820 that the second counter is less than the last value CLAST of the license matrix 700, the computer 100 increments the second counter in step 822. The computer 100 may then monitor the operations of the computer 100 in optional step 824 to harvest information related to (a.) a receipt by the computer 100 of additional acceptances of e-offers 106 of additional software programs or web services (b.) detection and storage in one or more product history data P.HIST regarding the interaction of the user with a software program or web service; and/or (c.) detection of violation by the computer 100 or the server 102 of an authorized license 506.A-506.N. The computer 100 proceeds from step 824 to step 826 to perform alternate or additional computational operations.

FIG. 9 is a flow chart of a third process of the computer 100 wherein a fourth aspect of the method of the present invention may be performed, and one or more additional terms or conditions 800.A-800.N may be offered to the user of the computer 100 and accepted, and one or more additional licenses 506.A-506. N may be authorized. In step 902 one or more additional term or condition 800.A-800.N is selected and then presented on the display screen in step 904. The computer 100 determines in step 906 whether an acceptance message has been received from the input device 120. When the computer 100 determines in step 906 that an acceptance message has been received from the input device 120, the computer 100 proceeds to step 908 to record the acceptance message in step 910 in the license matrix 700 and returns to step 810 of the process of FIG. 8:

When the computer 100 determines in step 906 that an acceptance message has not been received from the input device 120, the computer 100 proceeds to step 908 to record the lack of receipt of an acceptance message in step 912 in the license matrix 700 and optionally informs the remote server 102 of the failure to receive an additional acceptance message in step 914. The computer 100 proceeds from step 914 to step 820 of the process of FIG. 8.

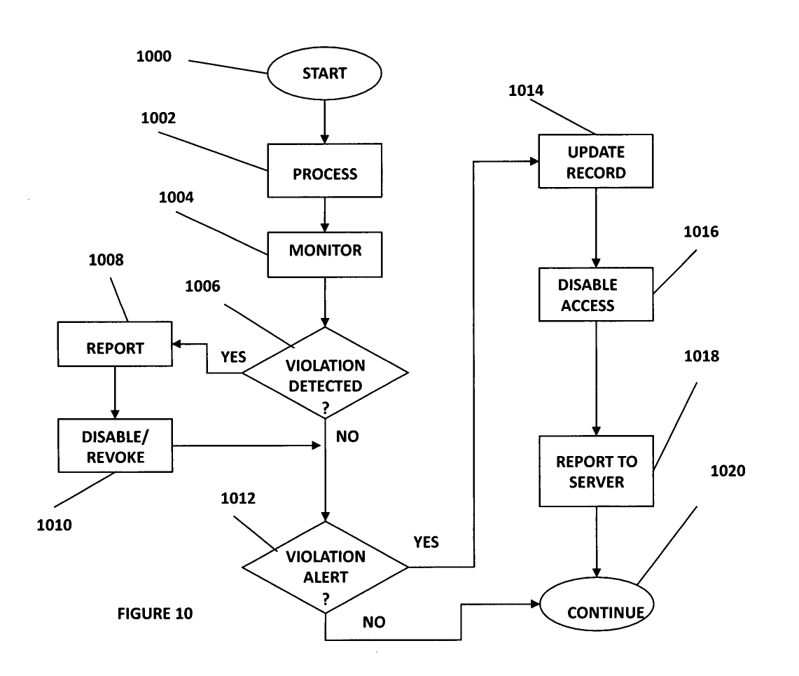

FIG. 10 is a flow chart of a third process of the computer 100 wherein a fourth aspect of the method of the present invention may be performed by the computer 100, and wherein the computer 100 may detect or receive an alert of a violation of an authorized license 506.A-506.N and thereupon record a license revocation and disable a licensed software or web service. In step 1002, the computer 100 initiates the execution of an exemplary software program 108.A and in step 1004 the computer 100 initiates monitoring the computational processing by the computer 100 of the software program 108.A. The computer determines in step 1006 whether a violation of the authorized software license has been detected. When a license violation is detected in step 1006, the computer 100 proceeds onto step 1008 to note a license revocation in the record P.REC.A of the exemplary software program 108.A and optionally report the license revocation to the remote server 102. In step 1010 the computer 100 disables access to the software program 108.A and/or web service.

The computer 100 proceeds from step 1010 or step 1006 to step 1012 and to determine therein whether the computer 100 has received a license violation alert via the network 104. When the computer 100 detects a receipt a license violation alert in step 1012, the computer 100 proceeds on to step 1014 to update the license record P.REC.A and to disables access to the software program 108.A or web service in step 1016. The computer 100 optionally reports the disablement of the software program 108.A or web service in step 1016 to the remote server 102 in step 1018. The computer 100 proceeds from step 1012 or step 1018 to step 1020 to perform alternate or additional computational operations.

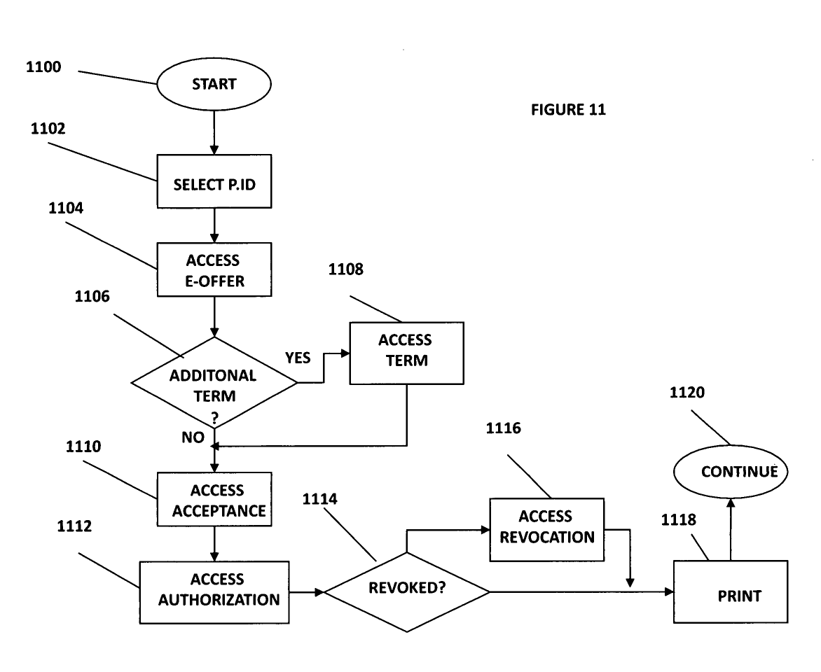

Referring now generally to the Figures and particularly to FIG. 11, FIG. 11 is a flowchart of another aspect of the method of the present invention that may be executed by the computer 100 and a hard copy of the authorized license 506.A-506. N may be generated. In step 1102 a license identifier P.ID.A-P.ID.N is selected and the associated unified e-offer 500 is accessed by the computer 100 in step 1104. The computer 100 determines in step 1106 whether any additional terms or conditions 800.A-800.N are associated with the selected license. When the computer 100 determines in step 1106 that additional terms or conditions 800.A-800.N are associated with the selected license 506.A-506.N, the computer 100 accesses the additional license terms and conditions 800.A-800. N in step 1108. The computer 100 accesses (a.) a recordation of an acceptance of the unified e-offer 500 in step 1110, and (b.) a recordation of the authorization of the license 506.A-506.N in step 1112. The computer 100 determines in step 1114 whether the license 506.A-506. N has been revoked and optionally access a recordation of the revocation in step 1116. The computer 100 generates a hard copy print that textually and/or graphically displays the information accessed in steps 1102 through 1116 in a print step 1118. It is understood that one or more of the steps 1102-118 may be performed in combination with, or solely by, the remote server 102. The computer 100 and/or remote server 102 proceed from step 1118 to step 1120 to perform alternate or additional computational operations.

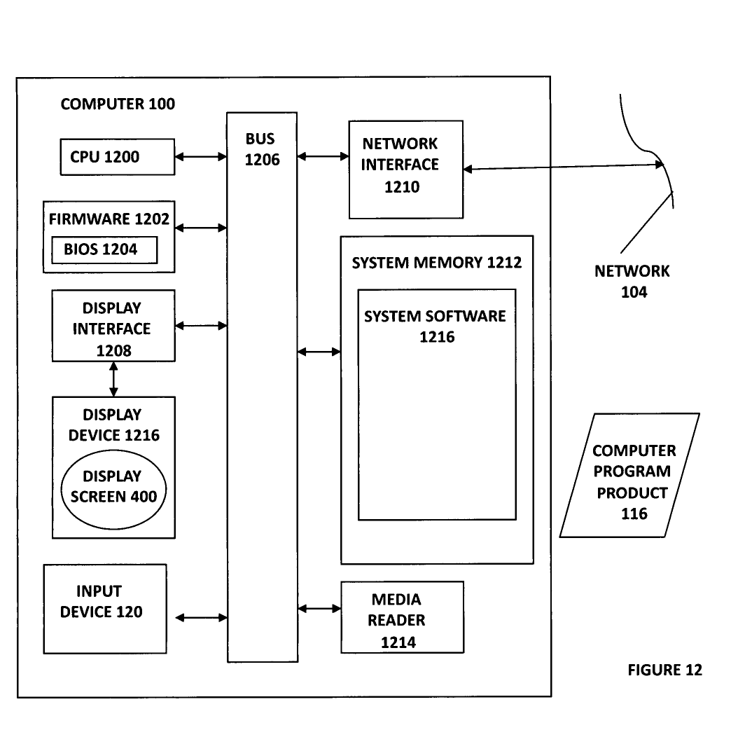

Referring now generally to the Figures and particularly to FIG. 12, FIG. 12 is a schematic diagram of the computer 100. The computer 100 includes a central processing unit 1200, or “CPU” 1200 and a firmware 1202. The firmware 1202 further includes a set of software-encoded instructions comprising a basic input output system 1204, or “BIOS” 1204, used to boot-up the computer 100. A communications bus 1206 bi-directionally communicatively couples the CPU 1200, the firmware 1202, a display interface 1208, the input device 120, a network interface 1210, a system memory 1212, and a media reader 1214. The display interface 1208 bi-directionally communicatively couples a display device 1216 comprising the display screen 400 with the communications bus 1206. The network interface 1210 bi-directionally communicatively couples the electronics communications bus 1206 and the electronics communications network 104.

The system memory 1212 is a random only access memory wherein a system software 1216 is maintained and optionally edited or modified by deletion, addition or updating of software encoded instructions.

The media reader 1214 is configured to read, and optionally write, machine readable, computer executable software encoded instructions from the computer program product 116. The media writer/reader 1214 and the associated computer program product 116 are selected and configure to provide non-volatile storage for the computer 100. Although the description of computer-readable media 116 contained herein refers to a mass storage device, such as a hard disk or CD-ROM drive, it should be appreciated by those skilled in the art that computer-readable media can be any available media that can be accessed by the computer 100.

By way of example, and not limitation, computer-readable media 116 may be or comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

The computer program product 116 may comprise machine-readable instructions which when executed by the computer 100 to cause the computer 100 to perform one or more steps as described in the Figures and enabled by the present disclosure, and/or generate, update, maintain and apply one or more data structures, e.g., the unified e-offer 500 and license matrix 700.

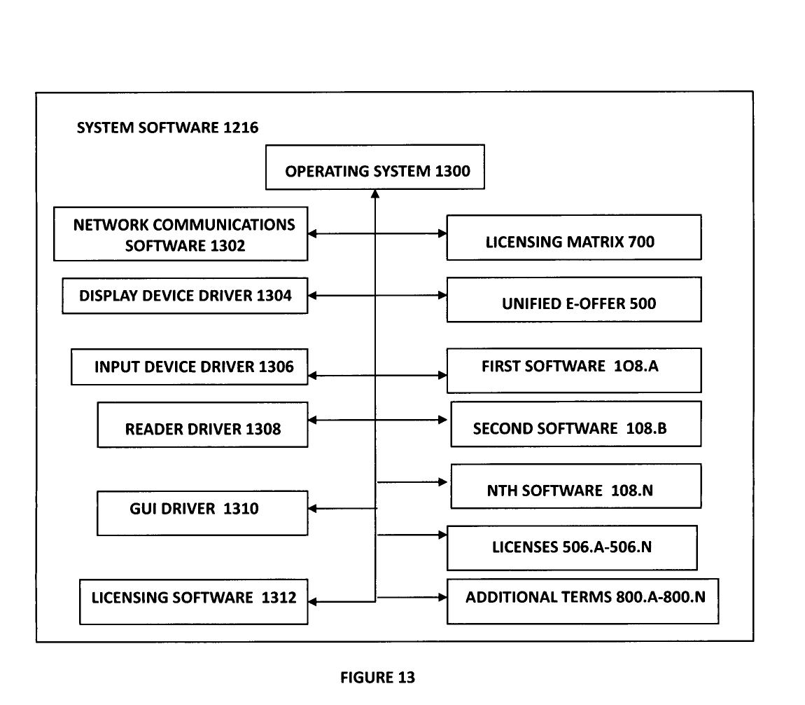

Referring now generally to the Figures and particularly to FIG. 13, FIG. 13 is a schematic diagram of the system software 1216 of the computer 100. An operating system 1300 that acts as a control layer between the hardware elements of the computer 100 and the software of the computer 100. A network communications software 1302 enables the network interface 1210 to bi-directionally couple the electronic communications network 104 with communications bus 1206 and the CPU 1200. A display device driver 1304 enables the CPU 1200 to direct the state of the display screen 400 to include the rendering of the desktop images of FIGS. 4 and 5. An input driver 1306 enables the CPU 1200 to accept, execute and interpret commands, instructions, data and selections from the input device 120. A reader driver 1308 enables the CPU 1200 to accept, execute and interpret software encoded programs, commands, instructions, data and selections from the computer program product 116.

A graphical user interface driver 1310, or “GUI” 1310, enables the computer 100 to visually render data, e.g., to render the desktop images of FIGS. 4 and 5. A licensing system software 1312 enables the computer to execute, instantiate, apply, or perform one or more aspects of the processes and data structures of FIGS. 1 through 11.

The system software 1216 further includes the license matrix 700, and the plurality of software applications 108.A-108.N.

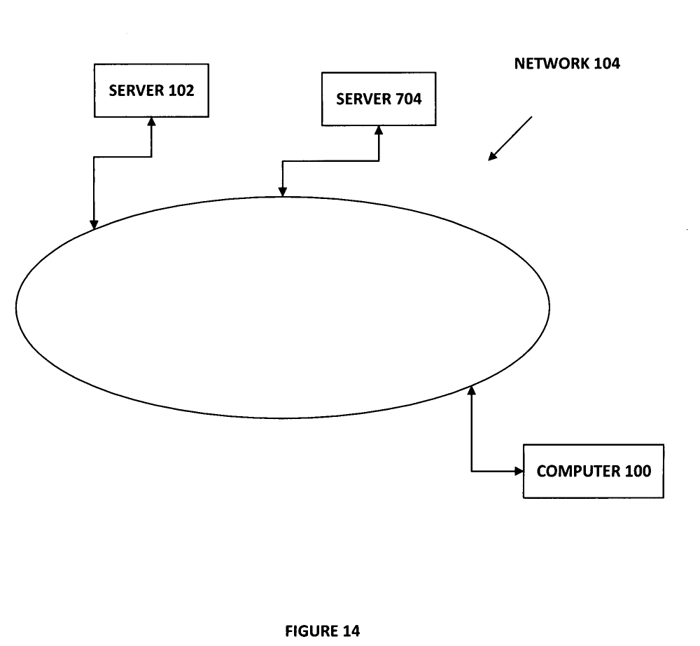

Referring now generally to the Figures and particularly to FIG. 14, FIG. 14 is a schematic diagram of the electronics communications network 104. The electronics communications network 104 may be or comprise the Internet, a computer network, a telephony network, a wireless communications network and/or a wireless telephone network. The server 102 may include one or more applications software programs 108.A-108.N that may be downloaded via the network 104 to the computer 100.

The computer 100 may be or comprise an electronic computer system, an information appliance configured for wireless Internet-enabled communication, a television set-top box, and/or a wireless communications capable communications device, such as (a.) a VAIO FS8900® notebook computer marketed by Sony Corporation of America, of New York City, N.Y., (b.) a wireless communications enabled SUN SPARCSERVER® computer workstation marketed by Sun Microsystems of Santa Clara, Calif. running LINUX® or UNIX® operating system; (c.) a wireless communications enabled personal computer configured for running WINDOWS XP® or VISTA® operating system marketed by Microsoft Corporation of Redmond, Wash.; (d.) a PowerBook G4® personal computer as marketed by Apple Computer of Cupertino, Calif.; (e.) an iPhone® cellular telephone as marketed by Apple Computer of Cupertino, Calif.; or (f.) a personal digital assistant enabled for wireless communications.

The server 102 may be or comprise an electronic computer system configured for bidirectional communications with the network 104, such as (a.) a SUN SPARCSERVER® computer workstation marketed by Sun Microsystems of Santa Clara, Calif. running LINUX® or UNIX® operating system; (b.) a server or personal computer configured for running WINDOWS XP® or VISTA® operating system marketed by Microsoft Corporation of Redmond, Wash.; (c.) a PowerBook G4® personal computer as marketed by Apple Computer of Cupertino, Calif.; (d.) an information appliance configured for Internet-enabled communication; and (e.) a wireless communications-enabled communications device.

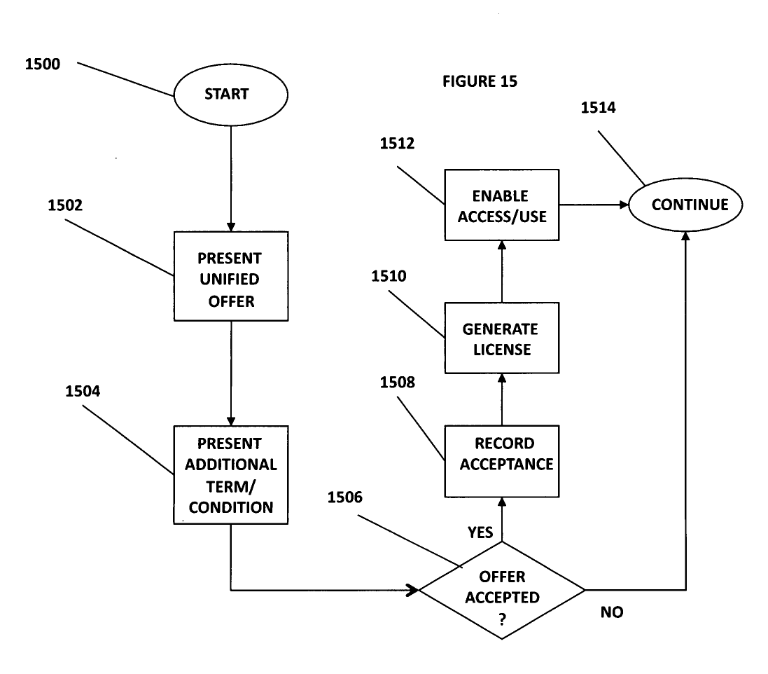

Referring now generally to the Figures and particularly to FIG. 15, FIG. 15 is a flowchart of a computer implemented process wherein a still alternate aspect of the method of the present invention is practiced when the computer 100 is offline and/or not in communication with the network 104 and/or the remote server 102 and/or remote server 704. In step 1502 the computer 100 displays the unified e-offer 500 to the user. In optional step 1404 one or more additional terms or conditions 800.A-800.N associated with an applications program 108.A-108.N are displayed by the computer 100. In step 1506 the computer 100 determines whether one or more indications of offers having been accepted have been received. The computer 100 records, in step 1508, any user acceptance message detected in step 1506, wherein the recordation is made in the system memory 1212, computer program product 116, and/or firmware 1202. The computer 100 generates and records one or more licenses 506.A-506.N, wherein the recordation is made in the system memory 1212, computer program product 116, and/or firmware 1202. In optional step 1510 in response to any user generated acceptance message detected in step 1506. The computer 100 may enable access to, or use of, one or more applications software 108.A-108. N as specified by any user generated acceptance message detected in step 1506. The computer 100 proceeds from step 1512 to step 1514 and to perform additional or alternative computational processes.

According to the method of FIG. 15, user modification the licensing matrix 700 is enabled while the computer 100 is offline and not in communication with the network 104, the remote server 102 and/or remote server 704. Further according to the method of FIG. 15, user selection and capability to accept the e-offer 500 is enabled while the computer 100 is offline and/or not in communication with the network 104, the remote server 102, and/or the remote server 704. Even further according to the method of FIG. 2, one, several or all of the aspects of the methods of FIGS. 1 through 13 are enabled while the computer 100 is offline and/or not in communication with the network 104, the remote server 102 and/or the remote server 702. Alternately or additionally, according to the method of FIG. 15, one, several or all of the aspects of FIGS. 1 through 14 may be applied, instantiated or performed by the computer 100 and without informational input or direction from the network 104, the remote server 102 and/or the remote server 704.

According to yet other additional aspects of the method of the present invention, the system software 1216 enables a user to direct the computer to (a.) modify the licensing matrix 700 while the computer 100 is offline and not in communication with the network 104, the remote server 102 and/or remote server 70; (b.) to accept the e-offer 500 while the computer 100 is offline and/or not in communication with the network 104, the remote server 102, and/or the remote server 704; and/or (c.) enable access to, or use of, one or more applications software 108.A-108.N while the computer 100 is offline and/or not in communication with the network 104, the remote server 102, and/or the remote server 704

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. A computer-implemented method for transforming an offer into an executed license agreement, the method comprising:
offering by presentation by a computer of a unified set of license terms and conditions to a user;
designating by the computer a first computational functionality,
designating by the computer a second computational; and
receiving an acceptance from the user of the unified set of terms and conditions, the acceptance indicating the first computational functionality or the second computational functionality, whereby the offer of the unified set of license terms and conditions is transformed into an executed license agreement.

2. The method of claim 1, further comprising enabling access to the user by the computer to at least one computational functionality indicated by the acceptance.

3. The method of claim 1, wherein the computer is bi-directionally communicatively coupled with a computer network and the computational functionality is enabled by the computer network.

4. The method of claim 3, further comprising downloading software from the computer network and to the computer, the software enabling access at least one computational functionality.

5. The method of claim 3, wherein the computer network at least partially comprises the Internet.

6. The method of claim 5, wherein the computational functionality indicated by the acceptance comprises a web service.

7. The method of claim 1, wherein the computer is bi-directionally communicatively coupled with a computer network, the method further comprising communicating the execution of the license agreement to a remote server via the computer network.

8. The method of claim 1, further comprising receiving a second acceptance of the unified set of terms and conditions, whereby the offer of the unified set of terms and conditions is transformed into a second executed license agreement; and permitting the user access to both the first computational functionality and the second computational functionality.

9. The method of claim 8, wherein the computer is bi-directionally communicatively coupled with a computer network, the method further comprising:
communicating the execution of the license agreement for the first computational functionality to a first remote server via the computer network; and
communicating the execution of the license agreement for the second computational functionality to a second remote server via the computer network

10. The method of claim 1, further comprising receiving a unified acceptance of the first set of terms and conditions, whereby the offer is transformed into a unified executed license agreement permitting the user access to both the first computational functionality and the second computational functionality.

11. The method of claim 1, further comprising designating a plurality of computational functionalities and enabling an independent and separate submission of an acceptance of the first set of terms and conditions in relation to each computational functionality.

12. The method of claim 1, further comprising offering by presentation by the computer of at least one additional condition to the user by the computer, wherein acceptance of the at least one additional condition is required to execute a license agreement for the first computational functionality.

13. The method of claim 12, further comprising receiving from the user by the computer an acceptance of the unified set of terms and conditions; and
receiving from the user by the computer an acceptance of the at least one additional condition, whereby a license agreement for the first computational functionality is executed.

14. The method of claim 13, further comprising enabling access to the first computational functionality by the computer.

15. The method of claim 1, wherein at least one computational functionality is enabled by software stored on the computer.

16. The method of claim 1, further comprising reading by the computer of a software module from a computer-readable medium, wherein the software module enables access to at least one computational functionality.

17. The method of claim 16, further comprising enabling access to the at least one computational functionality indicated by the acceptance by the computer.

18. An information technology system comprising:
one or more processors;
a memory accessible by the at least one of the one or more processors;
a display module configured to visually display information received from the memory;
a process operated by the one or more processors to manage software program selection, the process being effective to:
offer a unified set of license terms and conditions to a user;
designate a first computational functionality,
designate a second computational; and
receive an acceptance from the user of the unified set of terms and conditions, the acceptance indicating the first computational functionality or the second computational functionality, whereby the offer of the unified set of license terms and conditions is transformed into an executed license agreement.

19. The information technology system of claim 18, further comprising at least one network interface configured to bi-directionally communicatively couple the information technology system with a computer network, and wherein the execution of the license agreement is communicated to a remote server via the computer network.

20. A computer program product comprising:
a computer operable medium having computer readable code, the computer readable code being effective to:
offer a unified set of license terms and conditions to a user;
designate a first computational functionality,
designate a second computational; and
receive an acceptance from the user of the unified set of terms and conditions, the acceptance indicating the first computational functionality or the second computational functionality, whereby the offer of the unified set of license terms and conditions is transformed into an executed license agreement.
